(19) United States
(12) Patent Application Publication
(10) Pub. No.: US 2025/0036905 A1
(43) Pub. Date: Jan. 30, 2025

(54) STRUCTURAL ARRANGEMENT FOR AN IDENTIFICATION TAG

(71) Applicant: Danielle Cainy SOUZA SILVEIRA, Mandaguaçu (BR)

(72) Inventor: Danielle Cainy SOUZA SILVEIRA, Mandaguaçu (BR)

(21) Appl. No.: 18/717,356

(22) PCT Filed: Sep. 17, 2021
(86) PCT No.: PCT/BR2021/050398

§ 371 Date: Jun. 6, 2024

(30) Foreign Application Priority Data
Aug. 19, 2021 (BR) 20 2021 016467 6

(51) Int. Cl. G06K 19/06

(52) U.S. Cl. CPC G06K 19/06037

(57) ABSTRACT

This patent application belongs to the segment of accessories for identification in general, which notably refers to a TAG (label) of the QR code type with all the personal data of an individual or pet, it will also contain contact telephone numbers in case of emergency, your health data, for example, blood type, photo, if you have any psychological illness, among other information, all possible data for emergency assistance in case of an accident or loss, since the TAG can be used on bicycles, helmets, backpacks or any personal object. The tag (1) carries a QR code (2) where all types of information that the user deems necessary is stored, depending on its application. For example, you can enter your name, address, contact telephone number, contact in case of emergency, blood type, among other data

### TECHNOLOGICAL FIELD

This patent application belongs to the segment of accessories for identification in general, which notably refers to a TAG (label) of the QR code type with all the personal data of an individual or pet, it will also contain contact telephone numbers in case of emergency, your health data, for example, blood type, photo, if you have any psychological illness, among other information, all possible data for emergency assistance in case of an accident or loss, since the TAG can be used on bicycles, helmets, backpacks or any personal object.

### PRIOR ART ANALYSIS

Losing objects or being stolen always causes great inconvenience, the bureaucracy involved in redoing personal documents, objects can even be found by another people, but the owner is rarely found, due to lack of identification, this applies to people too, a child lost, an elderly person who does not remember the way back home or even in a possible accident and the person is unable to provide any personal information. Identification always helps us, but on the other hand carrying original documents or writing our data on objects is not always viable.

In prior art research, documents relating to the identification label were found, such as document No. BR102016015892-3 which deals with an identification label (10) and a method (100) of manufacturing the identification label (10) is provided. The identification tag (10) includes a first substrate (12) having a tag portion (14) and an attachment portion (16), a radio frequency identification (RFID) apparatus, a second substrate (30) having printed material (36) disposed on a surface (32) of the second substrate (30), and a resin-based material (38) encapsulating the RFID device (28) and the second substrate (30). The RFID device (28) is disposed on the label portion (14) of the first substrate (12), and the second substrate (30) is disposed on the RFID device (28). The second substrate (30) and the RFID device (28) are hermetically sealed, thus protecting them from chemicals, dirt, humidity and other environmental pollutants that may degrade the legibility of the printed material (36) and/or the operation of the RFID device (28).

There is also the document No. BR102015004786-0 which refers to the field of application of printed adhesives designed to identify products via radio frequency, known as multipurpose labels (1) and is composed of a layer of nylon (2)+glue (3)+inlay (4)+glue (3)+liner (10), supplied in rolls (5), making up detachable serrated units (6) (7), with small central extreme holes (8), which also receive a cut (9) in the nylon.

Finally, document No. BR112015004261-9 which deals with a sensor system (1000) comprising a tag (100), which comprises a removable radio frequency integrated circuit (130), an antenna (140) arranged in electrical communication with the integrated circuit (130) and a non-conductive coating (115) disposed on a surface of the label (100). The integrated circuit (130) comprises a memory element that provides electrical storage of data in binary code, and output terminals. The antenna (140) is in electrical communication with the output terminals. The non-conductive coating covers the integrated circuit and defines a perimeter (125). The perimeter (125) is disposed over and exposes a portion of the antenna (140).

Therefore, it is a fact that the documents mentioned in the paragraphs above, despite belonging to the same field of application, do not present any of the characteristics of the object now perfected, that is, an identification TAG with a QR code, thus ensuring that the even meets legal patentability requirements.

### BRIEF DESCRIPTION

Considering all the problems that were presented in the state of the art, the inventor, who has notorious knowledge about the sector, created and developed the aforementioned “IDENTIFICATION TAG FOR PERSONAL OBJECTS”, which aims to minimize the use of original documents and when leaving, and also facilitate identification in the event of an accident or for children, disabled people, animals and lost objects.

The purpose of this constructive arrangement is to present a product that will be applied to any object, clothing, collars, to have the personal identification of the owner thereof, a personalized product, for example, to a child in his school uniform or his swimwear when going to the beach, for a cyclist to put on their clothes or on their bike, for a pilot to put on their helmet, for people with some mental problems to put on their clothes, for animals to identify their owners.

This arrangement does not only take into account the mechanical and functional qualities, but also the shape, arrangement and strategic location of its parts and components which, correctly positioned, bring an increase in efficiency without causing any burden to users.

### DRAWINGS DESCRIPTION

To complement the present description in order to obtain a better understanding of the characteristics of the present arrangement and in accordance with a preferred practical implementation thereof, the attached description is accompanied by a set of drawings, where, in an exemplified manner, although non-limiting, if it represented its functioning:

FIG. 1 illustrates an image of the sticker tag with the QR code.

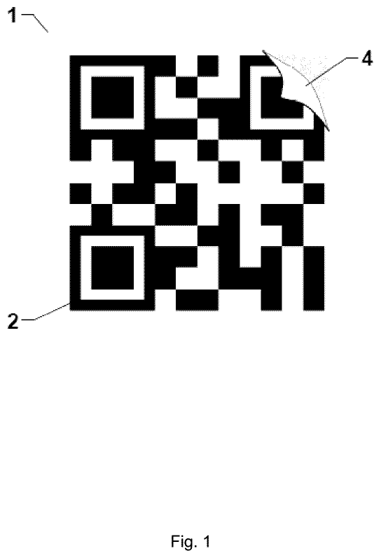

FIG. 2 reveals a helmet with the tag attached; and

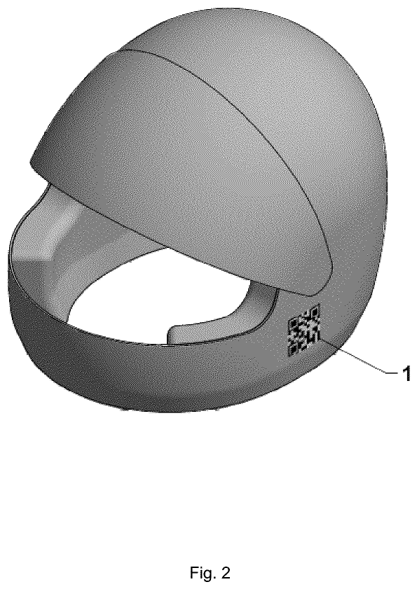

FIG. 3 shows a smartphone reading the tag.

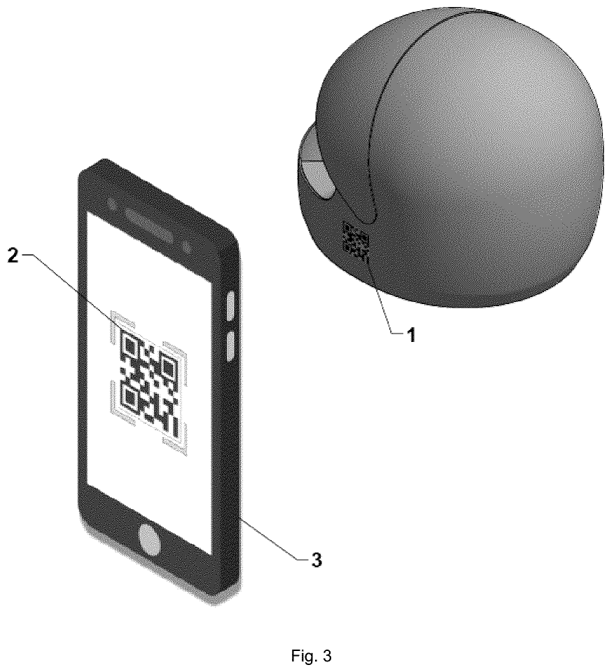

### DETAILED DESCRIPTION

With reference to the illustrated drawings, this arrangement refers to the “IDENTIFICATION TAG FOR PERSONAL OBJECTS”, more precisely a product for storing information and identifying people, animals or objects.

The tag (1) carries a QR code (2) where all types of information that the user deems necessary is stored, depending on its application. For example, you can enter your name, address, contact telephone number, contact in case of emergency, blood type, among other data.

This arrangement is an alternative to carrying physical and original documents, it is also a way to identify children, disabled people, animals and personal objects. Its application can be exemplified in the case of an accident, where the label already contains information about people, contacts and data about their health or in animals, children and objects that are lost, whoever finds it can access the contact and address data. To access the information, you only need a smartphone (3) with a camera and internet connection.

This tag (1) can be designed in the form of a sticker (4) to be placed on smooth bases, for example, on helmets, bicycles, motorcycles, cars, electronics, etc. And also, in the form of heat-adhesive labels for application to natural and synthetic fiber fabrics, for example, backpacks, uniforms and clothing in general.

It is true that when the present arrangement is put into practice, modifications may be introduced with regard to certain details of construction and shape, without this implying departing from the fundamental principles that are clearly substantiated in the claim framework, leaving thus understood that the terminology used was not intended to limit.

1. An identification tag for personal objects which concerns a label that carries a QR code where it is possible to store data and access it via a smartphone, which is capable of storing all types of information that the user deems necessary, depending on its application; allow the insertion of name, address, contact telephone number, contact in case of emergency, blood type, among other data; said arrangement being an alternative to carrying physical and original documents, also being a way of identifying children, disabled people, animals and personal objects; and, to access the information, the user will only need access to a smartphone with a camera and internet connection.

2. The identification tag for personal objects according to claim 1, wherein said tag can be designed in the form of a sticker being placed on smooth bases; can also be designed in the form of heat-adhesive labels for application to natural and synthetic fiber fabrics.
